(19) United States
(12) Patent Application Publication
(10) Pub. No.: US 2015/0169092 A1
(43) Pub. Date: Jun. 18, 2015

(54) SENSOR PANEL, TOUCH PANEL AND ELECTRONIC DEVICE

(71) Applicant: Samsung Electronics Co., Ltd., Gyeonggi-do (KR)

(72) Inventor: Hae Chang Lee, Gyeonggi-do (KR)

(21) Appl. No.: 14/335,646

(22) Filed: Jul. 18, 2014

(30) Foreign Application Priority Data
Dec. 18, 2013 (KR) 10-2013-0158311

(51) Int. Cl. G06F 3/041

(52) U.S. Cl. CPC G06F 3/041

(57) ABSTRACT

A sensor panel includes a first panel including a first substrate, a first transparent electrode formed on the first substrate, a first metal electrode formed on one side of the upper portion of the first transparent electrode, and a corrosion-resistant additional electrode arranged to be adjacent to the first metal electrode on the first transparent electrode, the additional electrode being formed on an externally exposed location. A touch panel includes a sensor panel comprising a first panel and a second panel that are laminated, and a circuit element bonded to a connection pad region formed on at least one of the first panel and the second panel, wherein at least one of the first panel and the second panel comprises a substrate, a transparent electrode formed on the substrate, a metal electrode, a corrosion-resistant additional electrode. Other embodiments including electronic devices are also disclosed.

### CROSS-REFERENCE TO RELATED APPLICATION AND CLAIM OF PRIORITY

The present application is related to and claims priority of Korean patent application No. 10-2013-0158311 filed Dec. 18, 2013, the disclosure of which is hereby incorporated in its entirety by reference.

### TECHNICAL FIELD

The present disclosure relates to a sensor panel, a touch panel and an electronic device having the sensor panel or the touch panel.

### BACKGROUND

Electronic devices have a communication function, and many are supplied in a size that is portable, so that many people use electronic devices. Such electronic devices include a touch function as a mode of input so that user inputs may be more easily performed.

The electronic devices use a touch panel to support the above-described touch function. The touch panel is arranged on a display unit. The touch panel is provided with a connection pad region to be connected to a circuit element, e.g., a flexible printed circuit board (FPCB) element. The connection pad region may be kept and stored in a state in which it is exposed to air before being connected to the circuit element, Moreover, a portion of the connection pad region may be put in a state in which it is exposed to air due to a mechanical tolerance even after being connected to the circuit element.

Signal connection lines formed of a metal are arranged on the above-described connection pad region. In this case, there is a limitation in that the metal arranged on the connection pad region is oxidized and corroded when put in contact with air. Such oxidation and corrosion may decrease the reliability of the product and lead to a defective product.

### SUMMARY

To address the above-discussed deficiencies, various embodiments of the disclosure are directed to a sensor panel and a touch panel including the sensor panel, the touch panel having a corrosion-resistant connection pad region.

According to an embodiment of the present disclosure, a sensor panel for a touch panel including a first panel includes a first substrate; a first transparent electrode formed on the first substrate; a first metal electrode formed on one side of the upper portion of the first transparent electrode; and a corrosion-resistant additional electrode arranged to be adjacent to the first metal electrode on the first transparent electrode, the additional electrode being formed on an externally exposed location.

The additional electrode may be made of one of silver (Ag), aluminum, titanium, nickel, stainless steel, a combination thereof or an alloy thereof.

The additional electrode may be formed through an inkjet technique or an etching process.

The sensor panel may further include at least one alignment mark arranged on at least one side of the first panel.

The first transparent electrode may be arranged on a touch sensor region sensing a change in a signal according to the sensing of a touch, the first metal electrode may form signal connection lines connected to an end of the first transparent electrode on a touch trace region corresponding to an edge of the touch sensor region, and the additional electrode may be arranged on a connection pad region to which a circuit element is bonded adjacently to ends of the signal connection lines.

The first transparent electrode may be arranged in a horizontal electrode pattern.

The sensor panel may further include an adhesive layer arranged on the first transparent electrode and the first metal electrode; and a second panel arranged on the adhesive layer, wherein the second panel may include a second substrate, a second transparent electrode, and a second metal electrode.

The additional electrode may be arranged on a connection pad region of the first panel, the connection pad region being bonded to a circuit element.

The sensor panel may further include a corrosion-resistant additional electrode arranged on a connection pad region of the second panel, the connection pad region being bonded to a circuit element, and a material of the additional electrode being a metal material different from a material of the second metal electrode.

According to another embodiment of the present disclosure, a touch panel includes a sensor panel including a first panel and a second panel that are laminated, and a circuit element bonded to a connection pad region formed on at least one of the first panel and the second panel, wherein at least one of the first panel and the second panel includes a substrate, a transparent electrode formed on the substrate; a metal electrode formed on a portion of the transparent electrode, a corrosion-resistant additional electrode formed in parallel to the metal electrode on the transparent electrode, wherein the additional electrode is arranged on the connection pad region and bonded to the circuit element.

The additional electrode may be any one of silver (Ag), aluminum, titanium, nickel, stainless steel, a combination thereof or an alloy thereof.

The additional electrode may be formed through an inkjet technique or an etching process.

The touch panel may further include at least one alignment mark arranged on at least one of the first panel and the second panel, wherein the at least one alignment mark is used when forming the additional electrode.

The touch panel may further include a conductive ball arranged on the additional electrode, wherein the conductive ball may be in contact with the circuit element.

The transparent electrode on which the metal electrode is arranged may be arranged in a horizontal electrode pattern.

The metal electrode may be connected to ends of the horizontal electrode patterns and arranged on a touch trace region of the sensor panel.

The touch panel may further include at least one of an insulator arranged on the metal electrode, and a first adhesive layer attaching the first panel to the second panel.

The touch panel may further include at least one of a cover substrate covering the sensor panel and fixing the circuit element, and a second adhesive layer arranged between the sensor panel and the cover substrate.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic external view of a touch panel according to an embodiment of the present disclosure.

FIG. 2 is a diagram for explaining a sensor panel according to an embodiment of the present disclosure.

FIG. 3 represents a portion of a cross-sectional view of a touch panel according to an embodiment of the present disclosure.

FIGS. 4A to 4D illustrate a manufacturing process of a sensor panel according to an embodiment of the present disclosure.

FIG. 5 represents a portion of another cross-sectional view of a touch panel according to an embodiment of the present disclosure.

### DETAILED DESCRIPTION

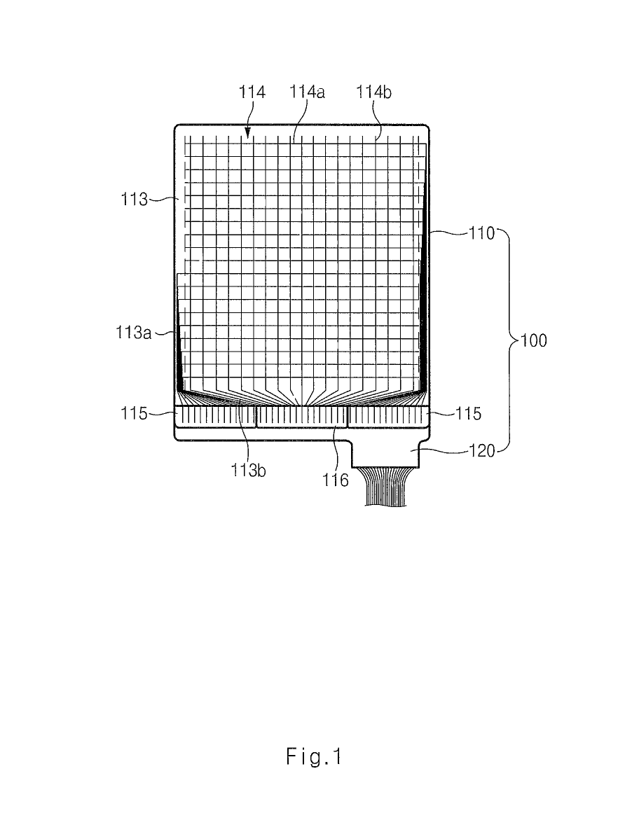

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Since the present disclosure may implement various modifications and may have several additional embodiments, particular embodiments will be illustrated in the drawings and described in the detailed description in detail. However, the present disclosure is not intended to be limited to particular embodiments, and it should be understood that the present disclosure covers all modifications, equivalents, and/or replacements that fall within the scope and technology of the present disclosure. In describing the drawings, similar components are denoted through the use of similar reference numerals.

The expression “include” or “may include” that may be used in describing the embodiments of the present disclosure indicates the presence of a disclosed corresponding function, operation and/or component but does not exclude one or more functions, operations or components in addition. Furthermore, in describing the embodiments of the present disclosure, it should be understood that the term “includes” or “has” indicates the presence of characteristics, numbers, steps, operations, components, parts or combinations thereof represented in the present disclosure but does not exclude the presence or addition of one or more other characteristics, numbers, steps, operations, components, parts or combinations thereof.

In describing the embodiments of the present disclosure, the expression “or” includes any and all combinations of enumerated words. For example, the expression “A or B” may include A, B, or both A and B.

In describing the embodiments of the present disclosure, the expression “a first”, “a second”, “firstly”, or “secondly” in the present disclosure may modify various components of the present disclosure but does not limit corresponding components. For example, the expression above does not limit the order and/or importance of corresponding components. The expression above may be used to distinguish one component from another component. For example, a first user device and a second user device are both user devices that are mutually different user devices. For example, without departing from the scope of rights of the present disclosure, a first component may be called a second component and similarly, the second component may also be called the first component.

When any component is referred to as being ‘connected’ to another component, it should be understood that the former can be ‘directly connected’ to the latter, or there may be another component in between. On the contrary, when any component is referred to as being ‘directly connected’ to another component, it should be understood that there may be no other component in between.

The terms used in describing the embodiments of the present disclosure are used only to describe specific embodiments and are not intended to limit the present disclosure. In the following embodiments, the terms in singular form may include the plural form unless otherwise specified.

Unless otherwise defined herein, all terms used herein including technical or scientific terms have the same meanings as those generally understood by a person skilled in the art. Terms defined in generally used dictionaries should be construed to have meanings matching contextual meanings in the related art and should not be construed as having an ideal or excessively formal meaning unless otherwise defined herein.

A sensor panel or a touch panel that is described in various embodiments of the present disclosure may be included in an electronic device. For example, the electronic device may include at least one of a smart phone, a tablet personal computer (PC), a mobile phone, a video phone, an e-book reader, a desktop PC, a laptop PC, a net book computer, a personal digital assistant (PDA), a portable multimedia player (PMP), an MP3 player, a mobile medical device, a camera, and a wearable device (e.g., a head-mounted-device (HMD) such as electronic glasses, electronic clothing, an electronic bracelet, an electronic necklace, an electronic accessory, an electronic tattoo, or a smart watch).

According to some embodiments, the electronic device may be a smart home appliance having a sensor panel or a touch panel that is described in the embodiments of the present disclosure. The smart home appliance may include, for example, at least one of a TV set, a digital video disk (DVD) player, an audio set, a refrigerator, an air conditioner, a cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic frame.

According to some embodiments, the electronic device may include at least one of various medical devices (e.g., magnetic resonance angiography (MRA) device, a magnetic resonance imaging (MRI) device, computed tomography (CT) device, a camera, and an ultrasonicator), a navigation system, a global positioning system (GPS) receiver, an event data recorder (EDR), a flight data recorder (FDR), a car infotainment device, electronic equipment for a ship (e.g., a navigation device or gyro compass for a ship), avionics, a security device, a head unit for a vehicle, an industrial or home robot, a financial institution's automatic teller's machine (ATM) or a store's point of sales (POS) device.

According to some embodiments, the electronic device may include at least one of a portion of a building/structure or furniture including a sensor panel or a touch panel, an electronic board, an electronic signature receiving device, a projector, and various measurement devices (e.g., a water, electricity, gas or electric wave measurement device). An electronic device according to the present disclosure may be one or more combinations of the above-described various devices. Moreover, an electronic device according to the present disclosure may be a flexible device. Moreover, it is obvious that an electronic device according to the present disclosure is not limited to the above-described devices.

FIG. 1 is a schematic external view of a touch panel according to an embodiment of the present disclosure.

Referring to FIG. 1, a touch panel 100 according to an embodiment of the present disclosure may include a sensor panel 110 and a circuit element 120.

The sensor panel 110 may include a touch sensor region 114 on which touch sensors are arranged, and a touch trace region 113 on which first signal connection lines 113a connected electrically to electrode patterns arranged on the touch sensor region 114 are arranged. In the following description, the sensor panel 110 is formed by laminating an upper panel 111 and a lower panel 112. However, embodiments of the present disclosure are not limited thereto. For example, the sensor panel 110 may be configured as one panel. In this example, when the sensor panel 110 is configured as one panel, the touch panel 100 according to an embodiment of the present disclosure may configure a connection pad region, to which the circuit element 120 is bonded, as a corrosion-resistant additional electrode of which the material is different from that of a metal electrode connected to a transparent electrode.

The touch sensor region 114 may include regions where a plurality of horizontal electrode patterns 114a and a plurality of vertical electrode patterns 114b are intersected and electrostatic capacity changes as an object approaches. The horizontal electrode patterns 114a and the vertical electrode patterns 114b may be made of a metal material that has electrical conductivity and is transparent. For example, the horizontal electrode patterns 114a and the vertical electrode patterns 114b may be provided as an indium tin oxide (ITO) based electrode.

At the intersection of the electrode patterns 114a and 114b provided on the touch sensor region 114, dummy patterns related to improving visibility may be provided. The dummy patterns may have a certain size and shape and a certain location to be able to prevent the touch sensor region 114 from becoming identified by lines due to the electrode patterns. For example, the dummy patterns may be located in an empty space formed by the intersection of the electrode patterns 114a and 114b, and may have various shapes such as a polygon and a free curved shape, and various areas.

Connection pad regions 115 and 116 may be provided on one side of the touch sensor region 114. One ends of the first signal connection lines 113a connected to the ends of the horizontal electrode patterns 114a may be located on the first one 115 of the connection pad regions 115 and 116. One ends of the second signal connection lines 113b connected to the ends of the vertical electrode patterns 114b may be located on the second one 116 of the connection pad regions 115 and 116. The first signal connection lines 113a and the second signal connection lines 113b may be provided with different metal materials from the horizontal electrode pattern 114a and the vertical electrode pattern 114b. The first signal connection lines 113a may be provided with a metal material having relatively more excellent electrical conductivity than the electrode patterns 114a and 114b, such as copper or copper alloy. At least some of the ends of first signal connection lines 113a and the second signal connection lines 113b arranged on the connection pad regions 115 and 120 may be connected electrically to the circuit element 120.

Some of the first signal connection lines 113a arranged on the first connection pad region 115 may be formed by using a material different from a metal material of a region such as a touch trace region 113. For example, some of the first signal connection lines 113a provided on the first connection pad region 115 may be provided as a corrosion-resistant metal material. On the other hand, the second signal connection lines 113b may be provided with a different metal material from the vertical electrode pattern 114b. Moreover, some portions of the second signal connection lines 113a arranged on the second connection pad region 116 may be provided with a corrosion-resistant metal material as in the first signal connection lines 113a of the first connection pad region 115.

Some of the first signal connection lines 113a connecting at least one of both ends of the horizontal one 114a of the electrode patterns 114a and 114b arranged on the touch sensor region 114 may be arranged on the touch trace region 113. Such a touch trace region 113 may be provided at a certain width at both edges of the touch sensor region 114 in FIG. 1. Some regions of the first signal connection lines 113a arranged on the touch trace region 113 may be formed to have a certain thickness through an inkjet technique or an etching process.

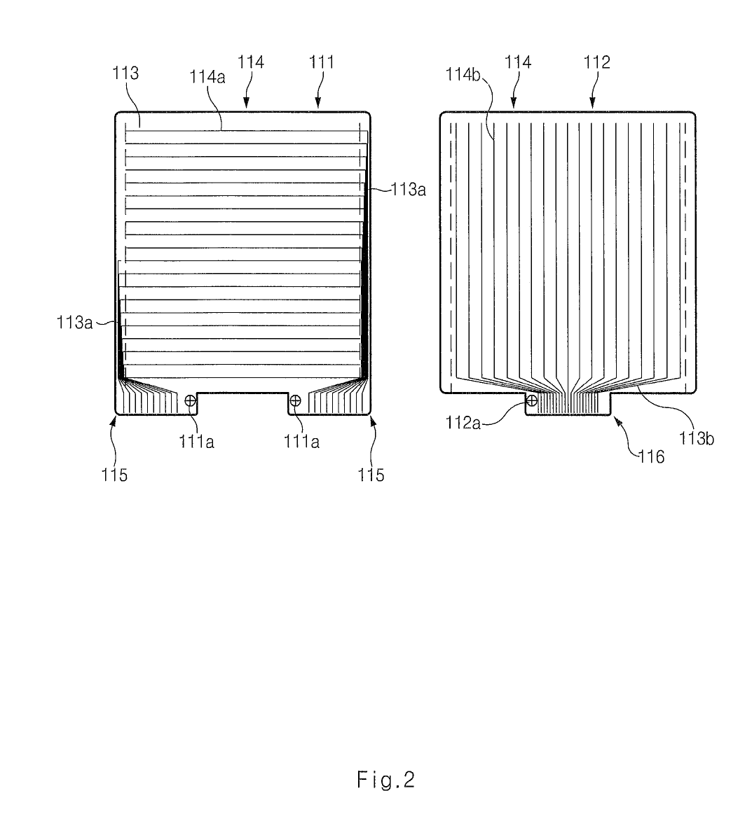

On the other hand, although it is described as an example that the touch trace region 113 is arranged at both edges of the touch sensor region 114, embodiments of the present disclosure are not limited thereto. For example, the touch trace region 113 may also be formed only on one of right and left edges of the touch sensor region 114. In this case, the first connection pad region 115 on which one ends of the first signal connection lines 113a arranged on the touch trace region 113 are arranged may be integrated into one region. The structure of the above-described sensor panel 110 is described in more detail with reference to FIG. 2.

The circuit element 120 may include a flexible printed circuit board (FPCB) that is at least partially connected to the connection pad regions 115 and 116 provided on the touch sensor region 114. The circuit element 120 may include electrodes that are in electric contact with the end of the signal connection lines provided on the connection pad regions 115 and 116. The circuit element 120 collects a signal for a change in electrostatic capacity sensed from the sensor panel 110. The circuit element 120 may perform a role of transmitting a collected signal to an external device, e.g., a central control device.

FIG. 2 is a diagram for explaining a sensor panel according to an embodiment of the present disclosure.

Referring to FIG. 2, the sensor panel 110 according to an embodiment of the present disclosure may be provided by the laminating of an upper panel 111 and a lower panel 112. The upper panel 111 may be a panel on which e.g., the horizontal electrode pattern 114a is arranged. The lower panel 112 may be a panel on which e.g., the vertical electrode pattern 114b is arranged. On the other hand, in the embodiment of the present disclosure, a panel on which the horizontal electrode pattern 114a is arranged is referred to as the upper panel 111 and a panel on which the vertical electrode pattern 114b is arranged is referred to as the lower panel 112, for the convenience of description. The upper panel 111 and the lower panel 112 may be called differently depending on where they are located in the laminating process.

The upper panel 111 may include the horizontal electrode pattern 114a arranged on the touch sensor region 114, the touch trace region 113, and the first signal connection lines 113a arranged on the first connection pad region 115. Some of the first signal connection lines 113a connected to the end of the horizontal electrode pattern 114a may be arranged on the touch trace region 113. Remaining portions extended from some of the first signal connection lines 113a formed on the touch trace region 113, e.g., one ends of the first signal connection lines may be arranged on the first connection pad region 115. The material of the first signal connection lines 113a provided on the first connection pad region 115 may be different from that of the first signal connection lines 113a formed on the touch trace region 113.

At least one first alignment mark 111a may be arranged on a certain region of the upper panel 111, e.g., a first connection pad region 115 or a touch trace region 113. The first alignment mark 111a may be provided on a certain region 113, 114, 115 or 116 of a substrate included in the upper panel 111 or may be provided on at least one of the transparent electrodes 114a and 114b and the metal electrodes 113a and 113b. On the other hand, when the alignment mark is provided on the lower panel 112, the alignment mark for the upper panel 111 may not be formed. The first alignment mark 111a may be used in at least one of various situations such as when manufacturing the sensor panel 110, when forming an additional electrode, and when bonding the circuit element 120.

The horizontal electrode patterns 114a may include a plurality of electrodes that have a certain thickness and are arranged on the touch sensor region 114 of a substrate at a certain interval. The horizontal electrode pattern 114a may be provided as a transparent electrode as described above. The end of the horizontal electrode patterns 114a may be connected to the first signal connection lines 113a on the touch trace region 113. Some of the horizontal electrode patterns 114a may be connected to the first signal connection lines 113a on the touch trace region 113 formed on the left edge of the touch sensor region 114, and the others of the horizontal electrode patterns 114a may be connected to the first signal connection lines 113a on the touch trace region 113 formed on the right edge of the touch sensor region 114.

Some of the first signal connection lines 113a provided on the first connection pad region 115 may be arranged on a region that is externally exposed while the upper panel 111 and the lower panel 112 are laminated. Thus, some regions of the first signal connection lines 113a arranged on the first connection pad region 115 may be provided with a corrosion-resistant metal material. For example, the material of the first signal connection lines 113a provided on the touch trace region 113 may be a copper material, and the material of the first signal connection lines 113a provided on the first connection pad region 115 may be silver (Ag), aluminum, titanium, nickel, stainless steel, a combination thereof or an alloy thereof.

The lower panel 112 may include the vertical electrode pattern 114b arranged on the touch sensor region 114, and the second signal connection lines 113b which are connected to the vertical electrode patterns 114b and of which the end is arranged on the second connection pad region 116. Moreover, at least one second alignment mark 112a may be arranged on one side of the lower panel 112. When the first alignment mark 111a is provided on the upper panel 111, at least one second alignment mark 112a may not be formed. The second alignment mark 112a may be used in at least one of various situations such as when manufacturing the sensor panel 110, when forming an additional electrode, and when bonding the circuit element 120.

One surface of the second connection pad region 116, e.g., a surface on which the second signal connection lines 113b are arranged may be externally exposed while the upper panel 111 and the lower panel 112 are laminated. Some of the second signal connection lines 113b arranged on the second connection pad region 116 may be provided with a corrosion-resistant metal material. Thus, some of the second signal connection lines 113b arranged on the second connection pad region 116 and some of the second signal connection lines 113b formed on regions other than the second connection pad region 116 may be provided with different materials.

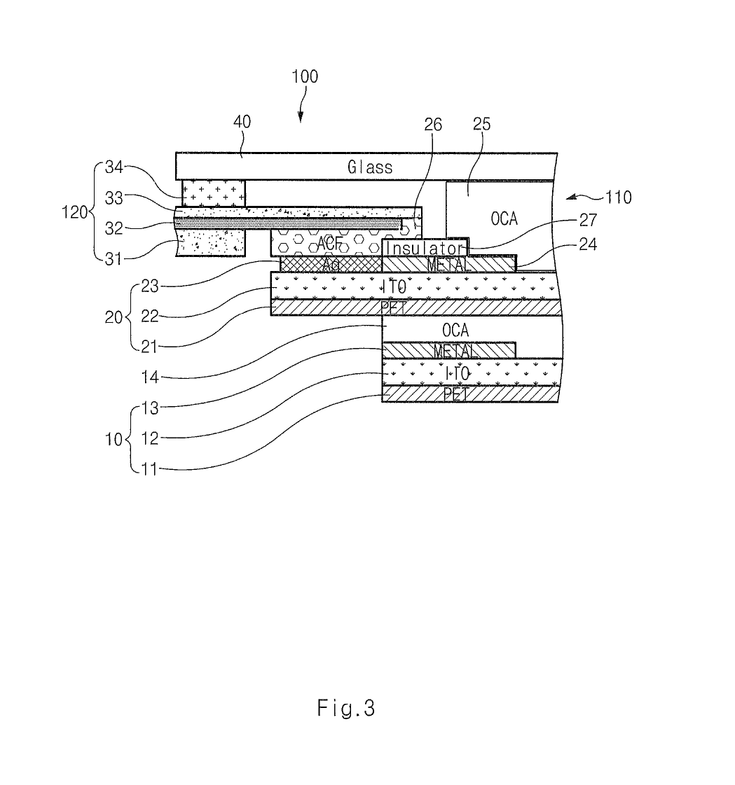

FIG. 3 is a portion of a cross-sectional view of a touch panel according to an embodiment of the present disclosure.

Referring to FIG. 3, the touch panel 100 according to an embodiment of the present disclosure may include the sensor panel 110, the circuit element 120 connected to one side of the sensor panel 110, and a cover substrate 40.

The sensor panel 110 may include a first panel 10 corresponding to a lower panel, a second panel 20 corresponding to an upper panel, a first adhesive layer 14 arranged between the first panel 10 and the second panel 20, and a second adhesive layer 25 arranged between the second panel 20 and the cover substrate 40. The second adhesive layer 25 may fix the second panel 20 and the cover substrate 40. As an example, a portion of the sensor panel 110 is laminated in such a manner that the second panel 20 protrudes more than the first panel 10. The protruding portion of the second panel 20 may be the connection pad regions 115 and 116 of the second panel 20.

The first panel 10 may include a first substrate 11, a first transparent electrode 12, and a first metal electrode 13.

The first substrate 11 may be provided with a transparent material such as a polyethylene terephthalate (PET) material. First transparent electrodes 12 may be arranged on the first substrate 11 at equal intervals or in-equal intervals. The first transparent electrode 12 may be based on ITO. The first transparent electrode 12 may be e.g., the horizontal electrode pattern or the vertical electrode pattern that is described above. The first metal electrode 13 may be provided on a portion of the first transparent electrode 12. For example, the first metal electrode 13 may be arranged on the touch trace region 113 corresponding to the edge of the first panel 10. The first metal electrode 13 may be formed of a metal material different from that of the first transparent electrode 12. The first adhesive layer 14 may be arranged on the first metal electrode 13 and the first transparent electrode 12 where the first metal electrode 13 is not formed. The first adhesive layer 14 may perform a role of fixing the first panel 10 to the second panel 20.

The second panel 20 may include a second substrate 21, a second transparent electrode 22, a second metal electrode 24, and an additional electrode 23. Furthermore, a conductive ball 26 and an insulator 27 may be further arranged on the second panel 20. The second substrate 21 may be formed of a PET material that is similar to or the same as that of the first substrate 11. The second substrate 21 may have a size similar to that of the first substrate and may be arranged in a direction similar to that of the first substrate 11. The second transparent electrode 22 that has a material similar or equal to that of the first transparent electrode 12 may be arranged on the second substrate 21. The first transparent electrode 22 may be a horizontal electrode pattern or a vertical electrode pattern. The second transparent electrode 22 may be arranged to intersect with the direction in which the first transparent electrode 12 is arranged.

The second metal electrode 24 may be arranged on the second transparent electrode 22. The second metal electrode 24 may be arranged on the edge region of the second transparent electrode 22, for example. The second metal electrode 24 may be provided with a material equal or similar to that of the first metal electrode 13. The second metal electrode 24 may be provided on regions other than the connection pad regions 115 and 116.

The additional electrode 23 may be provided on the connection pad regions 115 and 116. The additional electrode 23 may be arranged on the second transparent electrode 22. The second metal electrode 24 and the additional electrode 23 may be electrically connected. The additional electrode 23 may be formed of a metal material having corrosion resistance. For example, the additional electrode 23 may be formed of silver (Ag), aluminum, titanium, nickel, stainless steel, a combination thereof or an alloy thereof. Such an additional electrode 23 may be provided by using various techniques such as sputtering, vacuum deposition, or an inkjet technique. The insulator 27 may be arranged on the second metal electrode 24. The conductive ball 26 may be arranged on the additional electrode 23 and the insulator 27.

The conductive ball 26 may provide the electrical connection and adhesive force between the additional electrode 23 and the circuit element 120. The conductive ball 26 may have a size corresponding to the characteristic of a metal material used as the additional electrode 23. For example, when the additional electrode 23 has a silver (Ag) material, the conductive ball 26 may have a size corresponding to the silver (Ag) material. For example, a sample having a ball size smaller than or equal to 10 um may be applied.

The circuit element 120 may include a first FPCB film 31, an FPCB electrode 32, a second FPCB film 33, and a fixing member 34. The FPCB electrode 32 is arranged on the first FPCB film 31. The FPCB electrode 32 may be arranged so that a surface of the FPCB electrode 32 facing the conductive ball 26 is exposed. The second FPCB film 33 may be arranged on the FPCB electrode 32. The fixing member is arranged on the second FPCB film 33, so it is possible to fix the circuit element 120 to the cover substrate 40.

The cover substrate 40 may be provided as a transparent material such as a glass material. The cover substrate 40 may perform a role of fixing the circuit element 120. The cover substrate 40 is arranged to cover the sensor panel, so it is possible to perform a role of protecting the sensor panel 110.

As described above, in the case of the touch panel 100 according to an embodiment of the present disclosure, the connection pad regions 115 and 116 of the sensor panel 110 that are connected to the circuit element 120 may be formed of a metal electrode having corrosion resistance. Thus, the embodiment of the present disclosure may make possible to produce a more reliable product.

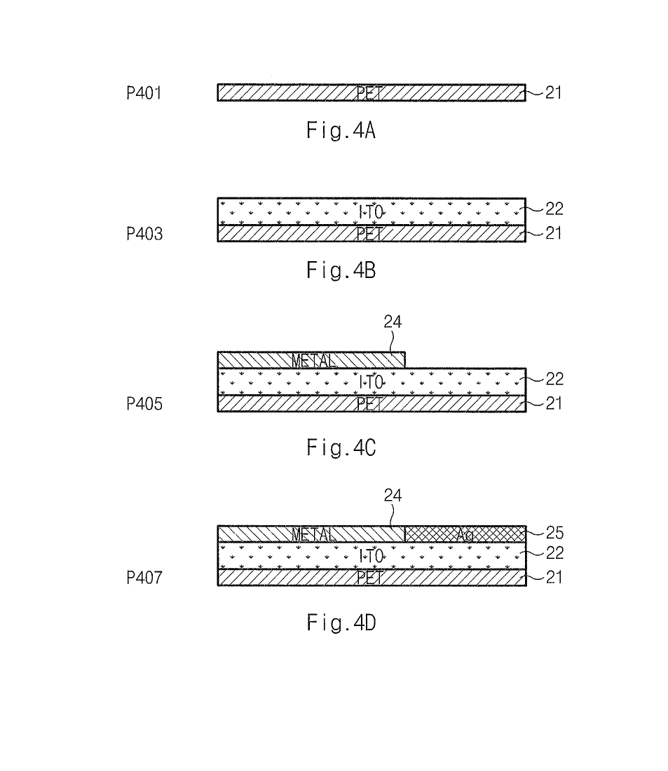

FIGS. 4A to 4D illustrate a method of manufacturing a sensor panel according to an embodiment of the present disclosure. In order to describe a process of manufacturing a sensor panel according to an embodiment of the present disclosure, the second panel 20 of the touch panel 100 previously described in FIG. 3 is used. However, the embodiments of the present disclosure are not limited thereto and the same method may also be applied to a process of forming the first panel 10. For example, an embodiment to of the present disclosure may be applied to the sensor panel 110 where the connection pad regions 115 and 116 are provided for the connection to the circuit element 120.

Referring to FIGS. 4A to 4D, the process of manufacturing the sensor panel according to an embodiment of the present disclosure may first provide the second substrate 21 in process P401. The second substrate 21 may be provided as a transparent material such as a PET material. After the second substrate 21 is arranged, the manufacturing process may include a process of forming the second transparent electrode 22 on the second substrate 21 as in process P403. The process of forming the second transparent electrode 22 may include first coating the second substrate 21 with a transparent electrode material in order to form a certain electrode pattern, and then applying an etching process. The formed second transparent electrode 22 may be a horizontal electrode pattern or a vertical electrode pattern, for example. The second transparent electrode 22 has a certain thickness and may be arranged in plurality at equal intervals or in-equal intervals.

After the second transparent electrode 22 is formed, the manufacturing process may include a process of forming the second metal electrode 24 as in process P405. In order to form the second metal electrode 24, the manufacturing process according to an embodiment of the present disclosure may include forming a metal electrode on some regions of the second transparent electrodes 22, such as an edge region of the second substrate 21, and etching to make a shape of an electrode as shown in FIG. 4C. In this case, it is also possible to wholly coat the second transparent electrode 22 with a material related to forming the second metal electrode 24 for easy processing, perform an etching process and make a shape of the second metal electrode. On the other hand, the second metal electrode 24 may be formed only on regions that are not exposed to the connection pad regions 115 and 116. To this end, the etching process may include defining a masking region so that the second metal electrode 24 is not formed on the connection pad regions 115 and 116. In the process of defining the masking region, at least one alignment mark 111a and 112a as previously described in FIG. 2 may be used.

After the second metal electrode 24 is formed, the manufacturing process may include a process of forming the additional electrode 23 as in process P407. The additional electrode 23 may be provided on the connection pad regions 115 and 116 adjacent to a location on which the second metal electrode 24 is arranged. The process of forming the additional electrode 23 may include arranging an additional electrode material on the connection pad regions 115 and 116 by using an inkjet technique. Alternatively, the process of forming the additional electrode 23 may include coating the connection pad regions 115 and 116 with an additional electrode material, and etching to be matched with the second metal electrode 24 pattern.

As described above, the process of manufacturing the sensor panel according to an embodiment of the present disclosure may include forming an electrode provided on the connection pad regions 115 and 116 bonded to the circuit element 120, as the additional electrode 23 having a corrosion resistant characteristic.

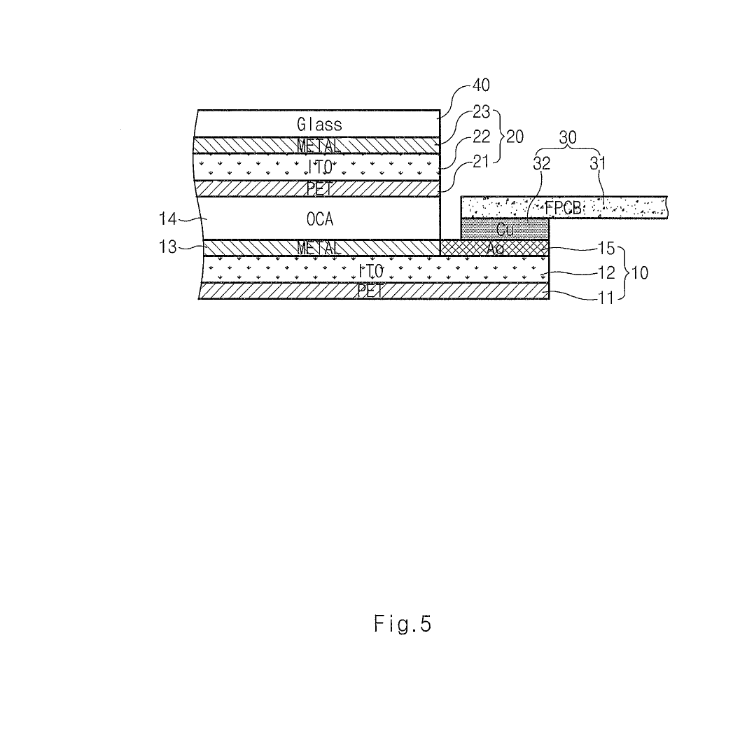

FIG. 5 represents a portion of another cross-sectional view of a touch panel according to an embodiment of the present disclosure.

The cross-sectional view of the touch panel 100 previously described in FIG. 3 may be a cross-sectional view corresponding to a region on which the second panel 20 corresponding to the upper panel 111 is connected to the circuit element 120. The cross-sectional view of the touch panel 100 represented in FIG. 5 may be a cross-sectional view corresponding to a region on which the first panel 10 corresponding to the lower panel 112 is connected to the circuit element 120.

Referring to FIG. 5, the touch panel 100 according to an embodiment of the present disclosure may include the sensor panel 110, the circuit element 120, and the cover substrate 40. On the other hand, although FIG. 5 shows that the cover substrate 40 is arranged to cover only the second substrate 21, the cover substrate 40 may be arranged to cover the sensor panel 110 and the circuit element 120 as previously mentioned. In addition, a fixing member 34 is arranged between the cover substrate and the circuit element 120, so it is possible to fix the circuit element 120 to one side of the cover substrate 40. Moreover, an adhesive layer may be further arranged between the sensor panel 110 and the cover substrate 40.

The sensor panel 110 may include the first panel 10, the second panel 20, and the first adhesive layer 14. The first panel 10 may be provided to protrude more than the second panel 20. The protruding portion of the first panel 10 that protrudes more than the second panel 20 may be the connection pad regions 115 and 116 of the first panel 10.

The first panel 10 may include the first substrate 11, the first transparent electrode 12, the first metal electrode 13, and the additional electrode 15 as shown in FIG. 5. The first metal electrode 13 and the additional electrode 15 may be arranged side by side on the first transparent electrode 12. The first metal electrode 13 and the additional electrode 15 may be provided to be in physical contact with each other. Alternatively, due to an error in a manufacturing process, there may be a certain gap between the first metal electrode 13 and the additional electrode 15. The first metal electrode 13 and the additional electrode 15 may have an electrically connected state through the first transparent electrode 12.

The FPCB electrode 32 of the circuit element 120 may be arranged on the additional electrode 15. The additional electrode 15 and the FPCB electrode 32 may be attached with adhesive force while having the electrically connected state. The conductive ball 26 may be arranged on the additional electrode 15 and the insulator 32. Alternatively, the additional electrode 15 and the FPCB electrode 32 may also have an adhesive state by a certain temperature and certain pressure. The second FPCB film of the circuit element 120 may be arranged on the FPCB electrode 32.

The first adhesive layer 14 may be arranged on the first panel 10 and the second panel 20 may be arranged on the first adhesive layer 14. In addition, the cover substrate 40 may be arranged on the second panel 20.

Although the detailed description exemplifies that the additional electrode 15 or 23 according to the embodiment of the present disclosure is formed on each of the connection pad region 115 of the first panel 10 and the connection pad region 116 of the second panel 20, the present disclosure is not limited thereto. The corrosion-resistant additional electrode 15 or 23 according to the embodiment of the present disclosure may be formed on at least one of the connection pad region 115 of the first panel 10 and the connection pad region 116 of the second panel 20. For example, the corrosion-resistant additional electrode 15 or 23 according to the embodiment of the present disclosure may be formed only on the connection pad region 115 of the first panel 10 or only on the connection pad region 116 of the second panel 20.

On the other hand, although FIGS. 1 to 5 depict that the additional electrode having corrosion resistance is arranged on the edge region of the first panel 10 or the edge region of the second panel 20, the present disclosure is not limited thereto. The metal electrode according to the embodiment of the present disclosure may be arranged on the touch trace region 113 on which the signal connection lines 113a and 113b connecting transparent electrodes are arranged. In addition, the additional electrode 15 or 23 according to the embodiment of the present disclosure may be provided on the connection pad region 115 or 116 to which the circuit element 120 is bonded. The touch trace region 113 and the connection pad regions 115 and 116 may be provided with various locations, shapes and thicknesses according to the design technique of the touch panel. For example, in a structure that the transparent electrode 12 or 22 for sensing a touch is arranged and the signal connection line 113a or 113b connected to one end of the transparent electrode 12 or 22, a technology applied to the sensor panel for the touch panel and the touch panel according to an embodiment of the present disclosure may include forming the electrode of the connection pad region 115 or 116 provided to be bonded to the circuit element 120, with a metal material different from that of the signal connection line 113a or 113b. In this case, the different metal material formed on the connection pad region 115 or 116 may be provided as a material having corrosion resistance.

As discussed above, according to the sensor panel for the touch panel and the touch panel of the present disclosure, various embodiments of the present disclosure may maintain a non-corrosive state even if the sensor panel for the touch panel is exposed to the air.

Moreover, various embodiments of the present disclosure may obtain a more complete electrical connection to the circuit element based on the sensor panel for the touch panel having corrosion resistance, so it is possible to decrease fraction defective.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A sensor panel for a touch panel, the sensor panel comprising:
a first panel, the first panel comprising:
a first substrate;
a first transparent electrode formed on the first substrate;
a first metal electrode formed on one side of an upper portion of the first transparent electrode; and
a corrosion-resistant additional electrode arranged to be adjacent to the first metal electrode on the first transparent electrode, the additional electrode being formed on an externally exposed location.

2. The sensor panel according to claim 1, wherein the additional electrode is made of one of silver (Ag), aluminum, titanium, nickel, stainless steel, a combination thereof or an alloy thereof.

3. The sensor panel according to claim 1, wherein the additional electrode is formed through an inkjet technique or an etching process.

4. The sensor panel according to claim 1, further comprising at least one alignment mark arranged on at least one side of the first panel.

5. The sensor panel according to claim 1, wherein the first transparent electrode is arranged on a touch sensor region for sensing a touch,
the first metal electrode forms signal connection lines connected to an end of the first transparent electrode on a touch trace region corresponding to an edge of the touch sensor region, and
the additional electrode is arranged on a connection pad region where a circuit element is bonded adjacently to ends of the signal connection lines.

6. The sensor panel according to claim 5, wherein the first transparent electrode is arranged in a horizontal electrode pattern.

7. The sensor panel according to claim 1, further comprising:
an adhesive layer arranged on the first transparent electrode and the first metal electrode; and
a second panel arranged on the adhesive layer, wherein the second panel includes a second substrate, a second transparent electrode, and a second metal electrode.

8. The sensor panel according to claim 7, wherein the additional electrode is arranged on a connection pad region of the first panel, the connection pad region being bonded to a circuit element.

9. The sensor panel according to claim 7, further comprising a corrosion-resistant additional electrode arranged on a connection pad region of the second panel, the connection pad region being bonded to a circuit element, and a material of the additional electrode being a metal material different from a material of the second metal electrode.

10. A touch panel comprising:
a sensor panel comprising a first panel and a second panel; and
a circuit element bonded to a connection pad region formed on at least one of the first panel and the second panel, wherein at least one of the first panel and the second panel comprises:
a substrate;
a transparent electrode formed on the substrate;
a metal electrode formed on a portion of the transparent electrode;
a corrosion-resistant additional electrode formed in parallel to the metal electrode on the transparent electrode, wherein the additional electrode is arranged on the connection pad region and bonded to the circuit element.

11. The touch panel according to claim 10, wherein the additional electrode is made of one of silver (Ag), aluminum, titanium, nickel, stainless steel, a combination thereof or an alloy thereof.

12. The touch panel according to claim 10, wherein the additional electrode is formed through an inkjet technique or an etching process.

13. The touch panel according to claim 10, further comprising at least one alignment mark arranged on at least one of the first panel and the second panel, wherein the at least one alignment mark is used when forming the additional electrode.

14. The touch panel according to claim 10, further comprising a conductive ball arranged on the additional electrode, wherein the conductive ball is in contact with the circuit element.

15. The touch panel according to claim 10, wherein the transparent electrode on which the metal electrode is arranged is arranged in a horizontal electrode pattern.

16. The touch panel according to claim 15, wherein the metal electrode is connected to ends of the horizontal electrode patterns and arranged on a touch trace region of the sensor panel.

17. The touch panel according to claim 10, further comprising at least one of:
an insulator arranged on the metal electrode; and
a first adhesive layer attaching the first panel to the second panel.

18. The touch panel according to claim 10, further comprising at least one of:
a cover substrate covering the sensor panel and fixing the circuit element; and
a second adhesive layer arranged between the sensor panel and the cover substrate.

19. An electronic device, comprising:
a sensor panel for a touch panel, the sensor panel comprising:
a first panel, comprising:
a first substrate;
a first transparent electrode formed on the first substrate;
a first metal electrode formed on one side of an upper portion of the first transparent electrode; and
a corrosion-resistant additional electrode arranged to be adjacent to the first metal electrode on the first transparent electrode, the additional electrode being formed on an externally exposed location.
